(19) United States
(12) Patent Application Publication
(10) Pub. No.: US 2017/0099235 A1
(43) Pub. Date: Apr. 6, 2017

(54) COMPUTERIZED TECHNOLOGY CHANGE EVALUATION AND MODIFICATION SYSTEM

(71) Applicant: BANK OF AMERICA CORPORATION, Charlotte, NC (US)

(72) Inventors: Annette H. Kellermann, Ellicott City, MD (US); Angela Barbarito Lukin, Seekonk, MA (US); Chih-Heng Wuu, Charlotte, NC (US); Stacey Donovan, Charlotte, NC (US); Robert J. Maloney, Iron Station, NC (US)

(21) Appl. No.: 14/875,908

(22) Filed: Oct. 6, 2015

(51) Int. Cl. H04L 12/911

(52) U.S. Cl. CPC H04L 47/828

(57) ABSTRACT

Disclosed is a computerized system for evaluating and modifying a technology change. The system typically includes a processor, a memory, and a change evaluation and modification module stored in the memory. The system for is typically configured for: receiving complexity data associated with a technology change; determining a complexity score for the technology change based on the complexity data; receiving change implementation context data associated with the technology change; determining a change implementation context score for the technology change based on the change implementation context data; receiving resource allocation data associated with the technology change; determining a resource allocation score for the technology change based on the resource allocation data; and modifying implementation of the technology change based on the complexity score, change implementation context score, and resource allocation score.

### FIELD OF THE INVENTION

The present invention embraces a computerized technology change evaluation and modification system. The system typically includes a processor and a memory. The system also typically includes change evaluation and modification module stored in the memory, which is typically configured for: receiving complexity data associated with a technology change; determining a complexity score for the technology change based on the complexity data; receiving change implementation context data associated with the technology change; determining a change implementation context score for the technology change based on the change implementation context data; receiving resource allocation data associated with the technology change; determining a resource allocation score for the technology change based on the resource allocation data; and modifying implementation of the technology change based on the complexity score, change implementation context score, and resource allocation score.

### BACKGROUND

Various methods exist to help businesses manage change events. That said, a need exists for an improved system for managing change events.

### SUMMARY

In one aspect, the present invention embraces a computerized system for evaluating and modifying a technology change and an associated method and computer program product. The system typically includes a processor and a memory. The system also typically includes a change evaluation and modification module stored in the memory and executable by the processor. In one embodiment, the change evaluation and modification module is configured for: receiving complexity data associated with a technology change; determining a complexity score for the technology change based on the complexity data; receiving change implementation context data associated with the technology change; determining a change implementation context score for the technology change based on the change implementation context data; receiving resource allocation data associated with the technology change; determining a resource allocation score for the technology change based on the resource allocation data; and modifying implementation of the technology change based on the complexity score, change implementation context score, and resource allocation score.

In one embodiment, the complexity data comprises complexity data associated with a plurality of complexity factors. In addition, the change evaluation and modification module is configured for: determining a factor complexity score for each of the complexity factors; determining an implementation stage associated with the technology change; and, based on the implementation stage, determining a factor weighting for each of the complexity factors. Furthermore, determining the complexity score comprises aggregating the factor complexity scores of the complexity factors based on the factor weightings.

In another embodiment, modifying implementation of the technology change comprises retrieving change requirements associated with the technology change and, based on the complexity score, change implementation context score, and resource allocation score, modifying the change requirements.

In another embodiment, the change evaluation and modification module is configured for: receiving status information associated with the technology change; based on the status information, determining that change requirements associated with a first change implementation stage have been completed; based on determining that the change requirements associated with the first change implementation stage have been completed, generating a permit to proceed to a second change implementation stage; and transmitting the permit to proceed to the second change implementation stage to a user.

In another embodiment, the change evaluation and modification module is configured for: determining a second complexity score, a second change implementation context score, and a second resource allocation score of a second technology change; determining that the technology change and the second technology change share a common resource; and based on the complexity score, change implementation context score, and resource allocation score of the technology change and the second complexity score, second change implementation context score, and second resource allocation score of the second technology change, increasing an allocation of the common resource to the technology change and reducing a second allocation of the common resource to the second technology change.

In another embodiment, the change evaluation and modification module is configured for: determining a nature of change score associated with a first time period, the technology change occurring during the first time period; determining that the nature of change score associated with the first time period exceeds a defined threshold; determining that if the technology change were moved to a second time period, then neither the nature of change score associated with the first time period nor a nature of change score associated with the second time period would exceed the defined threshold; and altering timing information associated with the technology change to indicate that the technology change will occur during the second time period.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts a change evaluation and modification system and operating environment in accordance with an exemplary embodiment of the present invention;

FIG. 2 schematically depicts a change evaluation and modification system in accordance with an exemplary embodiment of the present invention; and

FIG. 3 depicts a method of evaluating and modifying change in accordance with an exemplary embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

An “entity” may be any person or organization implementing a change and/or operating a change evaluation and modification system described herein. A “user” may be any person or entity using a change evaluation and modification system described herein. Often, a user is an employee of an entity using a change evaluation and modification system. In some instances a user has a management position within an entity using a change evaluation and modification system.

As used herein, the term “program” relates to a large body of work that has the goal of achieving one or more business outcomes. A program may have a defined beginning and end or may be ongoing. In contrast, the term “project” relates to an endeavor within a program undertaken to provide one or more outputs. These outputs typically help to achieve one or more business goal of an overarching program. While a program is often ongoing, projects typically have a defined beginning and end.

As used herein, the term “event” relates to a discrete modification, addition, or deletion of a business asset, system, process, product, or the like. Exemplary events may include installing new hardware in an existing entity system, updating software used by the entity, implementing a procedural change to a business process, rolling out a new product or service, or updating the entity's website. Events often occur as part of the execution of a program or project.

As used herein, the term “change” relates to any program, project, or event related to the modification, addition, deletion of one or more business assets, systems, processes, products, or the like. The term “technology change” refers to any technology related change. The technology involved in a technology change may include computer hardware or software.

In one aspect, the present invention embraces a system that may be used by an entity to evaluate the uncertainty of whether a change can be successfully implemented. Based on this evaluation, the implementation of the change may be modified to reduce uncertainty and increase the likelihood that the change can be successfully implemented.

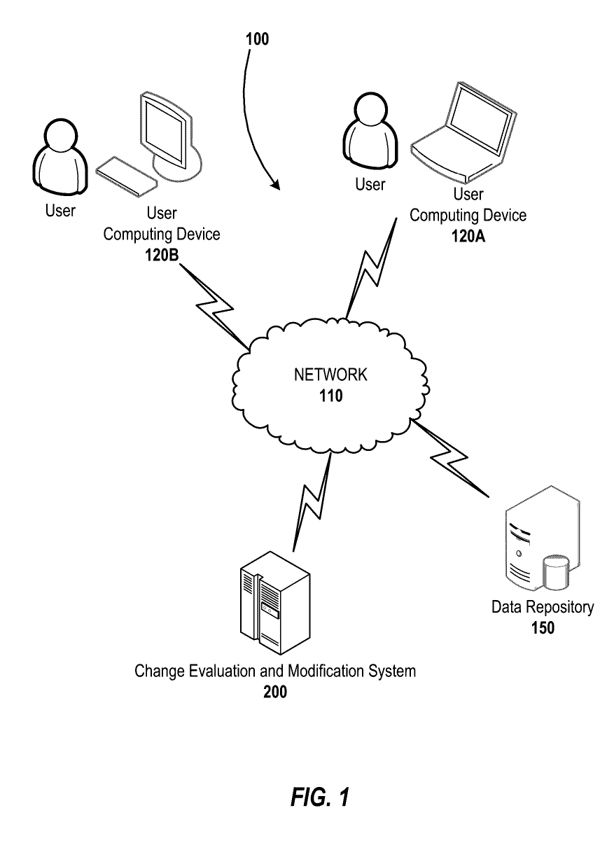

In this regard, FIG. 1 depicts an operating environment 100 according to one embodiment of the present invention that evaluates and modifies change for an entity (e.g., a financial institution). The operating environment includes a change evaluation and modification system 200. In addition, one or more users, each having a user computing device 120, such as a PC, laptop, mobile phone, tablet, television, mobile device, or the like, may be in communication with the change evaluation and modification system 200 via a network 110, such as the Internet, wide area network, local area network, Bluetooth network, near field network, or any other form of contact or contactless network. The operating environment may also include one or more data repositories 150 in communication with the change evaluation and modification system 200 via the network 110.

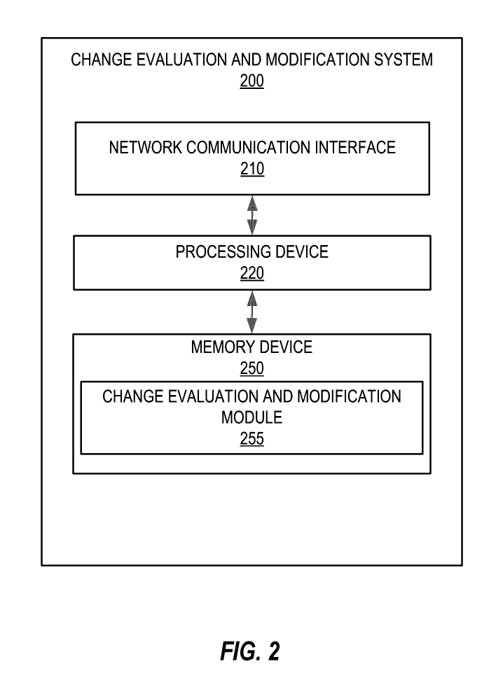

FIG. 2 depicts the change evaluation and modification system 200 in more detail. As depicted in FIG. 2, the change evaluation and modification system 200 typically includes various features such as a network communication interface 210, a processing device 220, and a memory device 250. The network communication interface 210 includes a device that allows the change evaluation and modification system 200 to communicate over the network 110 (shown in FIG. 1) with the user computing devices 120 and/or the data repositories 150. In this regard, the change evaluation and modification system 200 may use the network communication interface 210 to establish a communication channel with the user computing devices 120 and/or the data repositories 150. In some embodiments, the change evaluation and modification system 200 may cause the user computing devices 120 to display an interface (e.g., a graphical user interface) to allow users to interact with the change evaluation and modification system 200. The change evaluation and modification system 200 may interact with other entity systems, such as program or project management systems and/or asset management systems, which may be used to manage the planning and/or implementation of changes.

As used herein, a “processing device,” such as the processing device 220, generally refers to a device or combination of devices having circuitry used for implementing the communication and/or logic functions of a particular system. For example, a processing device 220 may include a digital signal processor device, a microprocessor device, and various analog-to-digital converters, digital-to-analog converters, and other support circuits and/or combinations of the foregoing. Control and signal processing functions of the system are allocated between these processing devices (e.g., processors) according to their respective capabilities. The processing device 220 may further include functionality to operate one or more software programs based on computer-executable program code thereof, which may be stored in a memory. As the phrase is used herein, a processing device 220 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device,” such as the memory device 250, generally refers to a device or combination of devices that store one or more forms of computer-readable media for storing data and/or computer-executable program code/instructions. Computer-readable media is defined in greater detail below. For example, in one embodiment, the memory device 250 includes any computer memory that provides an actual or virtual space to temporarily or permanently store data and/or commands provided to the processing device 220 when it carries out its functions described herein.

As noted, the change evaluation and modification system 200 is typically configured to evaluate a change and, based on this evaluation, automatically modify the implementation of the change. Accordingly, the change evaluation and modification system 200 typically includes one or more modules stored in the memory device 250, which facilitate change evaluation and management. As depicted in FIG. 2, the system 200 typically includes a change evaluation and modification module 255.

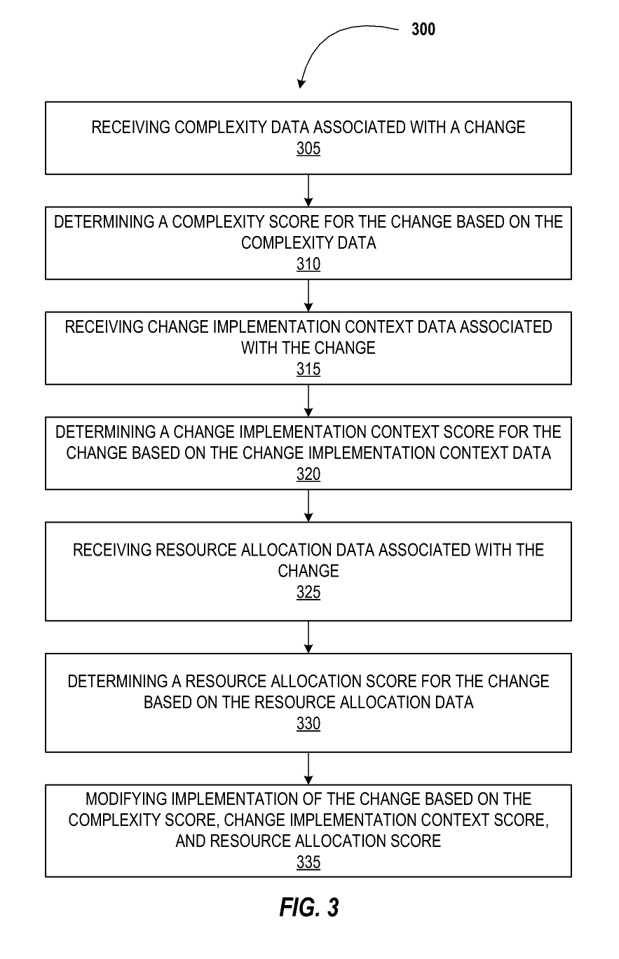

The change evaluation and modification module 255 is typically configured so that one or more users can interact (e.g., via user computing devices) with the change evaluation and modification system 200 in order to evaluate and manage change. In this regard, FIG. 3 depicts a method 300 of evaluating and modifying change that may be performed by the change evaluation and modification module 255.

Accordingly, at block 305, the change evaluation and modification module 255 is typically configured to receive complexity data (e.g., from a user computing device 120 or a data repository 150). The complexity data can be any type of data that relates to how complex a change is or is expected to be. Typically, the complexity data is related to one or more complexity factors such as: the cost of implementing the change (e.g., with lower cost being indicative of lower complexity), the duration of implementing the change (e.g., with a shorter duration being indicative of lower complexity), the technological complexity of the change (e.g., with less technological complexity being indicative of lower complexity), the degree of change required (e.g., with less change required and/or lower impact of such change on the entity or its customers being indicative of lower complexity), whether the timing of the implementation of the change is urgent or flexible (e.g., a change whose implementation is not urgently needed may have lower complexity), and/or whether the successful completion of the change is dependent upon other programs, projects, or events (e.g., a change whose implementation requires the successful completion of few other projects or events may have lower complexity) and/or whether other programs, projects, or events depend on the successful completion of this change. In some embodiments, a complexity factor may be the exposure of the change to various types of uncertainties, such as reputational impact if event is unsuccessful, financial impact if event is unsuccessful, the impact on critical business processes or systems, whether the event is in response to a regulatory requirement, the impact on critical business processes or systems, the impact on important entity applications, and the volume and importance of customer transactions impacted by the change. In some embodiments, a complexity factor may be the volatility associated with the successful completion of the change. For example, if the change has many change controls (e.g., requirements) that it must successfully complete during implementation (e.g., during planning, building, testing, and/or deployment/operation), then the change would have higher volatility, and thus higher complexity. In some embodiments, the complexity data may include raw data related to the one or more complexity factors. In some embodiments, the complexity data may include scores related to one or more of the complexity factors. For example, the complexity data may include information received from one of the user computing devices 120 that the complexity associated with one of the complexity factors is high, medium, or low.

Next, at block 310, the change evaluation and modification module 255 typically determines a complexity score for the change based on the complexity data. As noted, in some embodiments, the complexity data may include scores related to one or more of the complexity factors. If the complexity data includes raw data related to any of the complexity factors, this raw data may be used to determine a complexity factor score for such complexity factors (e.g., by determining whether such raw data is indicative of high, medium, or low complexity associated with a complexity factor). The scores related to the complexity factors may then be aggregated to determine a complexity score. In typical embodiments, aggregating the scores related to the complexity factors may include weighting the various complexity factors. More typically, the complexity factors may be weighted differently based on determining the implementation stage of the change. For example, the cost, volatility, technological complexity, and degree of change factors may have lower weightings at early change stages (e.g., when a change is being planned) and higher weighting at later change stages (e.g., when a change is being deployed). The duration factor may have lower weightings at early and later change stages and higher weighting at intermediate change stages (e.g., when a change is being built). The exposure, dependency, and urgency factors may have higher weightings at early change stages and lower weighting at later change stages. Such weighting may be defined by the entity or by a user.

At block 315, the change evaluation and modification module 255 is typically configured to receive change implementation context data (e.g., from a user computing device 120 or a data repository 150). The change implementation context data can be any type of data that relates to the level of knowledge or experience needed to successfully implement the change. Typically, the change implementation context data is related to one or more context factors such as: the regulatory knowledge required (e.g., with lower required regulatory knowledge being indicative of lower context), the required knowledge of products or services related to the change (e.g., with lower required knowledge being indicative of lower context), the knowledge of customers and entity employees required (e.g., with lower required customer/employee knowledge being indicative of lower context), the knowledge of different organizations within the entity required (e.g., with lower required knowledge being indicative of lower context), the complexity of the organization(s) within the entity that are implementing the change (e.g., with lower complexity being indicative of lower context), and the experience that the organization(s) implementing the change have with similar types of change (e.g., with higher experience being indicative of lower context). In some embodiments, the change implementation context data may include scores related to one or more of the change implementation context factors (e.g., scores indicating high, medium or low context associated with such factors).

Next, at block 320, the change evaluation and modification module 255 typically determines a change implementation context score for the change based on the change implementation context data. As noted, in some embodiments, the change implementation context data may include scores related to one or more of the context factors. If the change implementation context data includes raw data related to any of the context factors, this raw data may be used to determine a context factor score for such context factors (e.g., by determining whether such raw data is indicative of high, medium, or low complexity associated with a complexity factor). The scores related to the context factors may then be aggregated to determine a change implementation context score.

In some embodiments, the change implementation context score may be determined based on both (i) change implementation context data specific to the change and (ii) change implementation context data related to the organization within the entity implementing the change. For example, a user may provide scores related to context factors during the planning of a change, and these context factor scores may be combined with a context factor scores for the entity organization implementing the change to arrive at the change implementation context score.

In some embodiments, the change implementation context score may be determined for a group or portfolio of related changes rather than for each specific change. In this regard, change implementation context data for the group of changes may be evaluated to determine a change implementation context score for the group. This group change implementation context score may be reevaluated on a regular basis (e.g., annually) and/or whenever a new change is added to the group. This change implementation context score may then be used as the change implementation context score for each change within the group.

At block 325, the change evaluation and modification module 255 is typically configured to receive resource allocation data (e.g., from a user computing device 120 or a data repository 150). The resource allocation data can be any type of data that relates to where the resources (e.g., materials or personnel) needed to successfully implement the change are located. Typically, the resource allocation data is related to one or more resource allocation factors such as: whether non-entity resources (e.g., personnel or material provided by consultants or contractors) are required to implement the change (e.g., with the need for non-entity resources being indicative of likely more difficulty in implementing the change) and whether entity resources outside of the primary entity organization implementing the change are required (e.g., with the need for resources outside the primary entity organization being indicative of likely more difficulty in implementing the change). In some embodiments, the resource allocation data may include scores related to one or more of the resource allocation factors.

Next, at block 330, the change evaluation and modification module 255 typically determines a resource allocation score for the change based on the resource allocation data. As noted, in some embodiments, the resource allocation data may include scores related to one or more of the resource allocation factors. If the resource allocation data includes raw data related to any of the resource allocation factors, this raw data may be used to determine a resource allocation factor score for such resource allocation factors. The scores related to the resource allocation factors may then be aggregated to determine a resource allocation score. In this regard, beneficial resource allocation will typically result in a lower resource allocation score, and less desirable resource allocation, which may lead to more difficulty in implementing the change, will typically result in a higher resource allocation score.

In some embodiments, the resource allocation score may be determined for a group or portfolio of related changes (e.g., changes within the same program or project) rather than for each specific change. In this regard, resource allocation data for the group of changes may be combined to determine a resource allocation score for the group. This group resource allocation score may be reevaluated on a regular basis (e.g., annually) and/or whenever a new change is added to the group. This resource allocation score may then be used as the resource allocation score for each change within the group.

In some embodiments, the resource allocation score may be determined primarily based on resource allocation data related to the organization within the entity implementing the change. That said, if a change is identified as having specific resource allocation issues, the resource allocation score may be further based in part on change-specific resource allocation data.

Based on the determined complexity score, change implementation context score, and resource allocation score for the change, at block 335, the change evaluation and modification module 255 typically modifies the implementation of the change.

Typically, the change evaluation and modification module 255 will impose more rigorous requirements on a change if the change has a higher complexity score, change implementation context score, and/or resource allocation score. If the change has a lower complexity score, change implementation context score, and/or resource allocation score, the change evaluation and modification module 255 may impose less rigorous requirements on a change or even remove or reduce already defined requirements. In this regard, the change evaluation and modification module 255 may combine the complexity score, change implementation context score, and resource allocation score and determine if the combined score (e.g., an overall nature of change score) is below, above, or within one or more defined thresholds. For example, a requirement may be a change approval process (e.g., specifying those individuals or organizations within the entity that must review and approve change) that a change is required to complete before proceeding to each stage of implementation. A requirement may relate to process steps that a change must complete. A requirement may relate to testing or quality control steps that are required for a change to proceed to a next stage of implementation. A requirement may relate to remediation steps that a change is required to complete to reduce exposure to one or more complexity factors or other factors. A requirement may relate to reporting that must be completed during each stage of implementing a change. A requirement may be a step that must be successfully completed before a change may be permitted to proceed to a next stage of implementation.

Subsequently, the change evaluation and modification module 255 may receive status information related to the requirements and the change. If, based on this status information, the change evaluation and modification module 255 determines that all of the requirements associated with the current implementation stage of a change have been completed, then the change evaluation and modification module 255 may issue a permit (e.g., to the user computing device 120) indicating that the change can proceed to the next implementation stage. For example, if all of the planning requirements for a change have been completed, a permit to build the change may be issued, or if all of the building requirements for a change have been completed, a permit to deploy (e.g., operate) the change may be issued.

In some embodiments, the change evaluation and modification module 255 may be configured to alter the allocation of resources to the change based on the complexity score, change implementation context score, and/or resource allocation score. For example, if the complexity score, change implementation context score, and/or resource allocation score are relatively high, the change evaluation and modification module 255 may allocate additional resources to the change. By way of further example, if a first change and a second change are determined to share common resources, but the first change as a higher complexity score, change implementation context score, and/or resource allocation score than the second change, the change evaluation and modification module 255 may reduce the resources allocated to the second change and increase the resources allocated to the second change.

In a particular embodiment, the change evaluation and modification module 255 may be configured to alter the allocation of resources to the change based on the factor complexity scores of the complexity factors, the context factor scores of the context factors, and/or the resource allocation factor scores of the resource allocation factors. In particular, the change evaluation and modification module 255 may determine which factors have high factors scores (e.g., based on comparing such scores to a defined threshold) and which available resources would be suitable to remediate any identified high factor scores. In this regard, the change evaluation and modification module 255 may receive data related to available resources indicating which factors such resources may be suitable to remediate. Such data may include factor remediation scores indicating which factors resources may be suitable to remediate particular factors. For example, if a change has a high score for a particular context factor and the data related to available resources indicates that a particular resource or group of resources is well suited to remediate such context factor, then the allocation of such resource or group of resources may be increased for such change. Based on how well a particular resource or group of resources is able to remediate a particular factor, the data related to such particular resource or group of resources may be updated.

In some embodiments, the change evaluation and modification module 255 may be configured to alter the timing of the change based on the complexity score, change implementation context score, and/or resource allocation score. In this regard, the change evaluation and modification module 255 may (i) aggregate the scores (e.g., nature of change scores) for multiple changes occurring within a particular time period (e.g., day, week, or the like) to determine an aggregated nature of change score for the time period and (ii) determine that this aggregated nature of change score exceeds a defined threshold (e.g., a threshold defined by the entity or a user). Based this threshold being exceeded, the change evaluation and modification module 255 may then determine that moving one of the changes to a second time period may result in reducing the aggregated score for the first time period to below the threshold without increasing an aggregated nature of change score for the second time period to above the threshold. Thereafter, the change evaluation and modification module 255 may either (i) automatically modify timing information associated with the change to indicate that the change will occur in the second time period or (ii) provide a recommendation to a user that the change occur in the second time period, and once approval has been received from the user, modify the timing information associated with the change to indicate that the change will occur in the second time period.

In some embodiments, the change evaluation and modification module 255 may be configured to provide the complexity score, change implementation context score, resource allocation score, and/or nature of change score associated with a change to one or more users. The change evaluation and modification module 255 may automatically provide the complexity score, change implementation context score, and/or resource allocation score to a user based on one or more of these scores exceeding a defined threshold.

In some embodiments, the change evaluation and modification module 255 may be configured to aggregate the complexity scores, change implementation context scores, resource allocation scores, and/or nature of change scores associated with multiple changes. In this regards, the scores related to multiple events occurs as part of a project may be aggregated to determine corresponding scores for the project, and the scores related to multiple projects occurs as part of a program may be aggregated to determine corresponding scores for the program. In some embodiments, the scores related to a group or portfolio of related changes may be aggregated. In some embodiments, the scores related to changes being implemented by the same organization with the organization may be aggregated. Aggregated scores may then be provided to one or more users. For example, the aggregated scores may be provided as part of regular reports or may be automatically provided based on such aggregates scores exceeding one or more thresholds (e.g., thresholds defined by the entity or a user).

In some embodiments, the change evaluation and modification module 255 may be configured to update the complexity score, change implementation context score, and/or resource allocation score associated with a change using up to date data. This updating may occur periodically (e.g., weekly or monthly), may occur whenever a change is ready to proceed to the next implementation stage, or may occur when requested by a user.

As evident from the preceding description, the system described herein represents an improvement in technology by allowing a change to be evaluated and then modified in a way that reduces the uncertainty of whether the change can be successfully implemented. Accordingly, the system provides a technical solution for overcoming the problem of reducing the uncertainty of whether a change can be successfully implemented without imposing too lenient or too strict requirements on the change. Indeed, by modifying the change based on the performed evaluation, modification of the change can be tailored to such evaluation.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A computerized technology change evaluation and modification system, comprising:
a computer apparatus including a processor, a memory, and a network communication device; and
a change evaluation and modification module stored in the memory, executable by the processor, and configured for:
receiving complexity data associated with a technology change;
determining a complexity score for the technology change based on the complexity data;
receiving change implementation context data associated with the technology change;
determining a change implementation context score for the technology change based on the change implementation context data;
receiving resource allocation data associated with the technology change;
determining a resource allocation score for the technology change based on the resource allocation data; and
modifying implementation of the technology change based on the complexity score, change implementation context score, and resource allocation score.

2. The computerized technology change evaluation and modification system according to claim 1, wherein:
the complexity data comprises complexity data associated with a plurality of complexity factors;
the change evaluation and modification module is configured for:
determining a factor complexity score for each of the complexity factors;
determining an implementation stage associated with the technology change; and
based on the implementation stage, determining a factor weighting for each of the complexity factors; and
determining the complexity score comprises aggregating the factor complexity scores of the complexity factors based on the factor weightings.

3. The computerized technology change evaluation and modification system according to claim 1, wherein modifying implementation of the technology change comprises retrieving change requirements associated with the technology change and, based on the complexity score, change implementation context score, and resource allocation score, modifying the change requirements.

4. The computerized technology change evaluation and modification system according to claim 1, wherein the change evaluation and modification module is configured for:
receiving status information associated with the technology change;
based on the status information, determining that change requirements associated with a first change implementation stage have been completed;
based on determining that the change requirements associated with the first change implementation stage have been completed, generating a permit to proceed to a second change implementation stage; and
transmitting the permit to proceed to the second change implementation stage to a user.

5. The computerized technology change evaluation and modification system according to claim 1, wherein the change evaluation and modification module is configured for:
determining a second complexity score, a second change implementation context score, and a second resource allocation score of a second technology change;
determining that the technology change and the second technology change share a common resource; and
based on the complexity score, change implementation context score, and resource allocation score of the technology change and the second complexity score, second change implementation context score, and second resource allocation score of the second technology change, increasing an allocation of the common resource to the technology change and reducing a second allocation of the common resource to the second technology change.

6. The computerized technology change evaluation and modification system according to claim 1, wherein the change evaluation and modification module is configured for:
determining a nature of change score associated with a first time period, the technology change occurring during the first time period;
determining that the nature of change score associated with the first time period exceeds a defined threshold;
determining that if the technology change were moved to a second time period, then neither the nature of change score associated with the first time period nor a nature of change score associated with the second time period would exceed the defined threshold; and
altering timing information associated with the technology change to indicate that the technology change will occur during the second time period.

7. A computer program product for evaluating and modifying technology changes comprising a non-transitory computer-readable storage medium having computer-executable instructions for:
receiving complexity data associated with a technology change;
determining a complexity score for the technology change based on the complexity data;
receiving change implementation context data associated with the technology change;
determining a change implementation context score for the technology change based on the change implementation context data;
receiving resource allocation data associated with the technology change;
determining a resource allocation score for the technology change based on the resource allocation data; and
modifying implementation of the technology change based on the complexity score, change implementation context score, and resource allocation score.

8. The computer program product according to claim 7, wherein:
the complexity data comprises complexity data associated with a plurality of complexity factors;
the non-transitory computer-readable storage medium has computer-executable instructions for:
determining a factor complexity score for each of the complexity factors;
determining an implementation stage associated with the technology change; and
based on the implementation stage, determining a factor weighting for each of the complexity factors; and
determining the complexity score comprises aggregating the factor complexity scores of the complexity factors based on the factor weightings.

9. The computer program product according to claim 7, wherein modifying implementation of the technology change comprises retrieving change requirements associated with the technology change and, based on the complexity score, change implementation context score, and resource allocation score, modifying the change requirements.

10. The computer program product according to claim 7, wherein the non-transitory computer-readable storage medium has computer-executable instructions for:
receiving status information associated with the technology change;
based on the status information, determining that change requirements associated with a first change implementation stage have been completed;
based on determining that the change requirements associated with the first change implementation stage have been completed, generating a permit to proceed to a second change implementation stage; and
transmitting the permit to proceed to the second change implementation stage to a user.

11. The computer program product according to claim 7, wherein the non-transitory computer-readable storage medium has computer-executable instructions for:
determining a second complexity score, a second change implementation context score, and a second resource allocation score of a second technology change;
determining that the technology change and the second technology change share a common resource; and
based on the complexity score, change implementation context score, and resource allocation score of the technology change and the second complexity score, second change implementation context score, and second resource allocation score of the second technology change, increasing an allocation of the common resource to the technology change and reducing a second allocation of the common resource to the second technology change.

12. The computer program product according to claim 7, wherein the non-transitory computer-readable storage medium has computer-executable instructions for:
determining a nature of change score associated with a first time period, the technology change occurring during the first time period;
determining that the nature of change score associated with the first time period exceeds a defined threshold;
determining that if the technology change were moved to a second time period, then neither the nature of change score associated with the first time period nor a nature of change score associated with the second time period would exceed the defined threshold; and
altering timing information associated with the technology change to indicate that the technology change will occur during the second time period.

13. A method for evaluating and modifying technology changes, comprising:
receiving, via a computer processor, complexity data associated with a technology change;
determining, via a computer processor, a complexity score for the technology change based on the complexity data;
receiving, via a computer processor, change implementation context data associated with the technology change;
determining, via a computer processor, a change implementation context score for the technology change based on the change implementation context data;
receiving, via a computer processor, resource allocation data associated with the technology change;
determining, via a computer processor, a resource allocation score for the technology change based on the resource allocation data; and
modifying, via a computer processor, implementation of the technology change based on the complexity score, change implementation context score, and resource allocation score.

14. The method according to claim 13, wherein:
the complexity data comprises complexity data associated with a plurality of complexity factors;
the method further comprises:
determining a factor complexity score for each of the complexity factors;
determining an implementation stage associated with the technology change; and
based on the implementation stage, determining a factor weighting for each of the complexity factors; and
determining the complexity score comprises aggregating the factor complexity scores of the complexity factors based on the factor weightings.

15. The method according to claim 13, wherein modifying implementation of the technology change comprises retrieving change requirements associated with the technology change and, based on the complexity score, change implementation context score, and resource allocation score, modifying the change requirements.

16. The method according to claim 13, further comprising:
receiving status information associated with the technology change;
based on the status information, determining that change requirements associated with a first change implementation stage have been completed;
based on determining that the change requirements associated with the first change implementation stage have been completed, generating a permit to proceed to a second change implementation stage; and
transmitting the permit to proceed to the second change implementation stage to a user.

17. The method according to claim 13, further comprising:
determining a second complexity score, a second change implementation context score, and a second resource allocation score of a second technology change;
determining that the technology change and the second technology change share a common resource; and
based on the complexity score, change implementation context score, and resource allocation score of the technology change and the second complexity score, second change implementation context score, and second resource allocation score of the second technology change, increasing an allocation of the common resource to the technology change and reducing a second allocation of the common resource to the second technology change.

18. The method according to claim 13, further comprising:
determining a nature of change score associated with a first time period, the technology change occurring during the first time period;
determining that the nature of change score associated with the first time period exceeds a defined threshold;
determining that if the technology change were moved to a second time period, then neither the nature of change score associated with the first time period nor a nature of change score associated with the second time period would exceed the defined threshold; and
altering timing information associated with the technology change to indicate that the technology change will occur during the second time period.
